(19) United States
(12) Patent Application Publication
(10) Pub. No.: US 2026/0072447 A1
(43) Pub. Date: Mar. 12, 2026

(54) POOL CLEANING DEVICE AND ITS CONTROLLING METHOD

(71) Applicant: AIPER GLOBAL PTE. LTD., Singapore (SG)

(72) Inventors: Xiantao Qian, Shenzhen (CN); Jinhui Liao, Shenzhen (CN)

(21) Appl. No.: 19/230,797

(22) Filed: Jun. 6, 2025

(30) Foreign Application Priority Data
Sep. 11, 2024 (CN) 202411269343.8
Sep. 30, 2024 (CN) 202411391412.2

(51) Int. Cl. G05D 1/648; G05D 105/10; G05D 107/00; G05D 111/10

(52) U.S. Cl. CPC G05D 1/6486; G05D 2105/10; G05D 2107/29; G05D 2111/10

(57) ABSTRACT

Disclosed are a pool cleaning device and a method for controlling the pool cleaning device. The method includes: controlling the device to move by a main path in a pool; obtaining at least one image about a current environment within an angle of view of at least one image sensor of the device; determining at least one cleaning target in the current environment based on the at least one image; controlling the device to leave the main path in the main route to clean the at least one cleaning target; and controlling the device to return to the main path to continue moving by the main path after cleaning the at least one cleaning target.

### CROSS-REFERENCE

The present disclosure claims benefits of, and priorities to Chinese Patent Application No. 202411391412.2 filed on Sep. 30, 2024 and Chinese Patent Application No. 202411269343.8 filed on Sep. 11, 2024, the disclosures of which are hereby expressly incorporated by reference herein in their entirety.

### TECHNICAL FIELD

The present disclosure relates to a pool cleaning device and a method for controlling the pool cleaning device.

### BACKGROUND

A pool cleaning device (also referred to as a pool cleaning robot) may be utilized to automatically clean pool facilities such as swimming pools.

### SUMMARY

Disclosed is a method for controlling a pool cleaning device. The method may comprises: controlling the pool cleaning device to move by a main path in a pool; obtaining, from at least one image sensor of the pool cleaning device, at least one first image about a current environment within an angle of view of the at least one image sensor; determining at least one cleaning target in the current environment and a position of the at least one cleaning target based on the at least one first image; controlling the pool cleaning device to leave the main path and move toward the position of the at least one cleaning target to clean the at least one cleaning target; and controlling the pool cleaning device to return to the main path to continue moving by the main path after cleaning the at least one cleaning target.

In one or more embodiments, a spacing between the main path and an adjacent path of the main path may depend on a width of the angle of view or a physical size of the pool cleaning device. For example, the spacing may be more than half of the width and/or be less than or equal to the width. For example, the spacing may be larger than a body width of the pool cleaning device.

In one or more embodiments, the main path and the adjacent path may be parallel.

In one or more embodiments, the determining the at least one cleaning target in the current environment and the position of the at least one cleaning target based on the at least one first image may comprise: determining one or more cleanable targets in the current environment based on the at least one first image; and determining at least one cleanable target within a predetermined range from the one or more cleanable targets as the at least one cleaning target.

In one or more embodiments, the predetermined range may depend on a predetermined threshold related to an accuracy of image recognition.

In one or more embodiments, the controlling the pool cleaning device to leave the main path to clean the at least one cleaning target may comprise: controlling the pool cleaning device to clean at least one first cleaning target among the at least one cleaning target, the at least one first cleaning target being at a side of the current path; controlling the pool cleaning device to return to the main path after cleaning the at least one first cleaning target; and in a case where the at least one cleaning target further comprises at least one second cleaning target at other side of the main path, controlling the pool cleaning device to leave the main path to clean the at least one second cleaning target. For example, in a case where it is determined that the at least one cleaning target comprises multiple cleanable targets on both side of the main path, the at least one second cleaning target at the other side of the main path among the at least one cleaning target may be determined.

In one or more embodiments, the controlling the pool cleaning device to leave the main path to clean the at least one cleaning target may further comprise: obtaining, from the at least one image sensor, at least one second image about a current environment within a current angle of view during returning to the main path after cleaning the at least one first cleaning target; and determining, based on the at least one second image, whether the at least one cleaning target comprises the at least one second cleaning target.

In one or more embodiments, a sequence for cleaning the at least one cleaning target may depend on a distance between the at least one cleaning target and the pool cleaning device.

In one or more embodiments, the distance may comprise a longitudinal distance or a linear distance between the at least one cleaning target and the pool cleaning device.

In one or more embodiments, a route of the pool cleaning device returning to the main path may be perpendicular to the main path.

Also disclosed is a pool cleaning device which may comprise at least one image sensor and a controller. The at least one image sensor may be configured to obtain at least one first image about a current environment within an angle of view of the at least one image sensor while the pool cleaning device is controlled by the controller to to move by a main path in a pool. The controller may be configured to load programs for performing the above method from a memory of the pool cleaning device and to execute the programs to control the pool cleaning device.

### BRIEF DESCRIPTION OF THE DRAWINGS

FIG. 1 schematically shows an example of a process of controlling a pool cleaning device in an embodiment.

FIG. 2 schematically shows an example of a method for controlling a pool cleaning device in an embodiment.

FIG. 3 schematically shows an example of a process of the method for controlling the pool cleaning device in an embodiment.

FIG. 4 schematically shows an example of a process of the method for controlling the pool cleaning device in an embodiment.

FIG. 5 schematically shows an example of the pool cleaning device in an embodiment.

### DETAILED DESCRIPTION

Embodiments of the present disclosure will be described hereinafter in detail with reference to accompany drawings. In the drawings, the same reference numbers will be assigned to the same or equivalent parts for which descriptions will not be repeated.

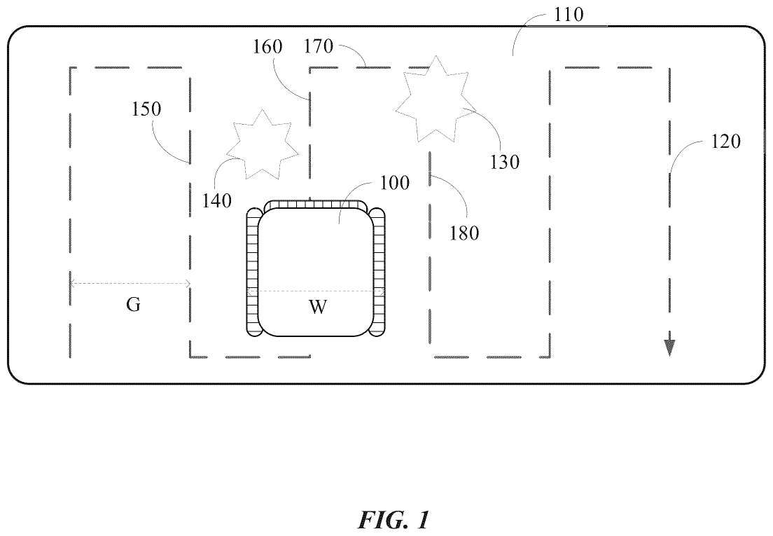

The pool cleaning device 100 may be equipped with a moving mechanism for example including one or more more of at least one moving wheel, at least one crawler, at least one water jet nozzle, and so on, one or more of which may be driven by electricity generated by a motor in the pool cleaning device 100. Further, pool cleaning device 100 may be equipped with a cleaning mechanism for example including one or more of at least one roller brush, at least one water suction port or water inlet and so on, one or more of which may be driven by electricity generated by the motor in the pool cleaning device 100. As shown in FIG. 1, the cleaning mechanism of the pool cleaning device 100 may operate while the pool cleaning device 100 is moving on a bottom, wall and/or water surface of a pool 110 by a pre-planned route 120 with its moving mechanism driven by electricity, to clean an area where the pool cleaning device 100 is currently located, for example including filtering water and absorbing dirt.

In an embodiment, the route 120 may be designed with a higher density. For example, a spacing G between each pair of adjacent paths in the route 120 may be planned small enough, which, for example, may be less than or equal to a body width or cleaning width (for example, an effective working width of the roller brush or water suction port) W of the pool cleaning device 100, so that garbage in the pool 110 may be either on the route 120 such as the garbage 130 in FIG. 1, or between a pair of adjacent paths of the route 120 such as the garbage 140 between the adjacent paths 150 and 160 in FIG. 1.

Thus, for example, the pool cleaning device 100 may clean up at least a part of the garbage 140 when traveling along the path 150, clean up at least another part of the garbage 140 when traveling along the path 160, and clean up the garbage 130 when traveling along the paths 170 and 180, so that an expected cleaning coverage and an avoidance of cleaning omissions may be achieved for the pool cleaning device 100.

The higher the density of the route 120, the longer a total length of the route 120, resulting in a longer time and a more power consumption for the pool cleaning device 100 to complete a full coverage cleaning. For example, for a large piece of garbage sparsely distributed at the bottom of the pool, the cleaning efficiency may be reduced in a case of using the route 120 with a higher density.

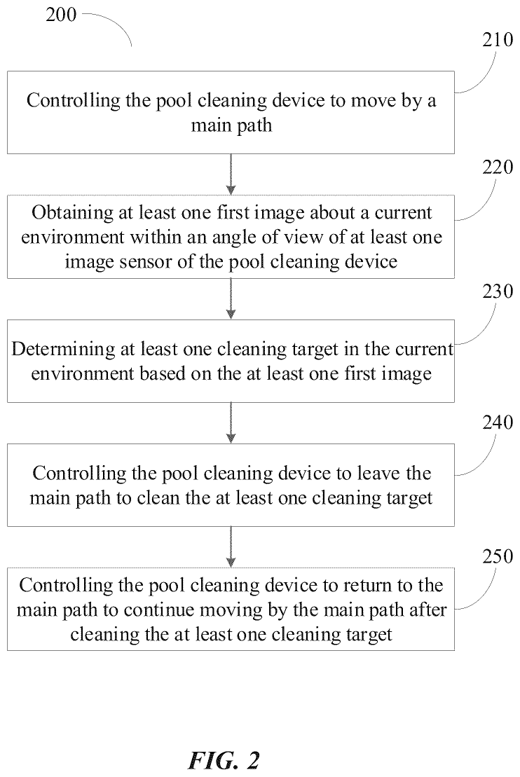

In another embodiment, an exemplary method 200 as shown in FIG. 2 may be executed to control the pool cleaning device 100 to perform full coverage cleaning on the pool 110, by which, the pool cleaning device 100 may perform full coverage cleaning on the pool 110 by a sparser (and accordingly, shorter) planned route while avoiding cleaning omissions, so that the cleaning coverage rate may be ensured in a more efficient and energy-saving manner.

The exemplary method 200 may be executed for example by a controller or a processor (described below) in the pool cleaning device 100, and may include steps 210, 220, 230, 240, and 250, as shown in FIG. 2.

In the step 210, the pool cleaning device 100 may be controlled to move along or by paths in the pool 110. For example, the paths may be at least a part of a planned main route that can cover at least a part of the complete map of the pool 110. Or, the paths, along or by which the pool cleaning device 100 is controlled to move for example according to a set of instructions or rules from the controller, may finally correspond to or form the main route that can cover at least a part of the complete map of the pool 110. In various embodiments, any suitable method may be adopted to determine or obtain data about at least a part of the complete map of the pool 110, and any suitable method may be adopted to determine the main route for the pool cleaning device 100. In addition, in various embodiments, the main route may be in any suitable form or shape, such as an S-shape and a spiral shape.

Then, while the pool cleaning device 100 is moving by the main route, the step 220 may be performed to obtain, from at least one image sensor (for example, a camera, a radar, a LIDAR, or the like) of the pool cleaning device 100, at least one image about a current environment within an angle of view of the at least one image sensor. For example, depending on types and functions of the image sensors configured on the pool cleaning device 100, the at least one obtained image may include a color image, a grayscale image, a laser point cloud image, and any other suitable image. In addition, the at least one obtained image may include at least one static image and/or at least one dynamic image.

Then, in the step 230, at least one cleaning target in the current environment may be determined based on the at least one image obtained in the step 220. For example, in the step 230, at least one cleaning target within a predetermined range from the pool cleaning device 100 may be determined based on the at least one image obtained in the step 220 by any suitable image processing and analysis method or target recognition method such as an image convolution neural network. For example, a distance (for example, a longitudinal distance, a linear distance, or the like) between the at least one cleaning target determined in the step 230 and the pool cleaning device 100 may be less than a predetermined threshold. For example, the predetermined threshold may be 0.5 m, 0.6 m, 0.7 m, or the like. For example, the predetermined threshold may be determined according to an accuracy of image recognition or target orientation recognition, so that one or more cleanable targets (e.g. all the cleanable targets) captured by the at least one image and/or recognized based on the at least one image may be determined as the cleaning targets in the step 230.

Then, the step 240 may be performed to control the pool cleaning device 100 to leave the path where the pool cleaning device 100 is currently located on the main route (also referred to as “current path” or “main path” herein), and to clean the at least one cleaning target determined in the step 230.

For example, after the pool cleaning device 100 has cleaned the at least one cleaning target determined in the step 230, the step 250 may be performed to control the pool cleaning device 100 to return to the main path left in the step 240, and to control the pool cleaning device 100 to continue moving by the main path.

In the exemplary method 200, while controlling the pool cleaning device 100 to move along the main path in the pool, in a case where at least one cleaning target within a predetermined range from the pool cleaning device 100 is recognized based on the at least one obtained image by a suitable image processing and analyzing method or target recognition method, the pool cleaning device 100 is controlled to temporarily leave the main path to clean the at least one recognized cleaning target, and then to return to the main path to continue moving along the main path. Thus, the pool cleaning device 100 is enabled to clean the pool 110 by a sparser (and accordingly, shorter) route while avoiding cleaning omissions, so that a more efficient and energy-saving cleaning manner may be achieved while ensuring the cleaning coverage.

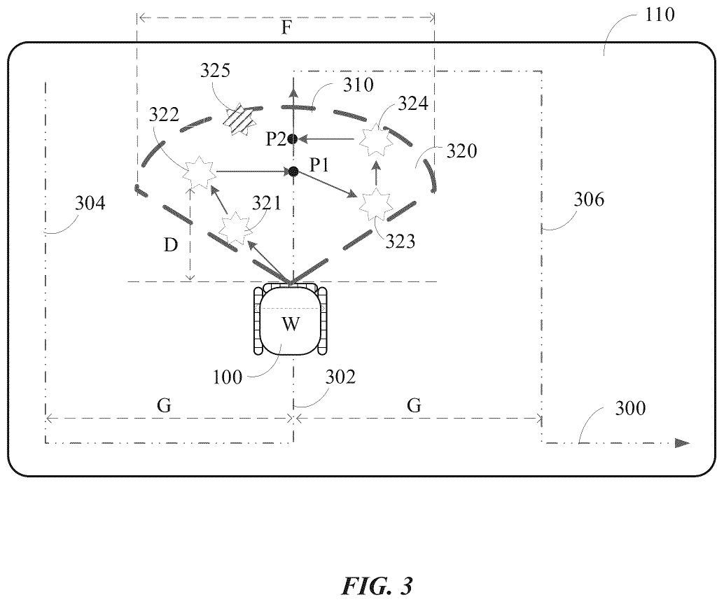

FIG. 3 illustrates details and examples of an execution of the exemplary method 200.

As shown in FIG. 3, in the step 210 of the exemplary method 200, the pool cleaning device 100 may be controlled to move in the pool 110 for example according to a main route 300 as shown by a double-dotted dashed line with an arrow in FIG. 3, wherein the main route 300 can cover at least a part of a complete map of the pool 110.

In various embodiments, any suitable method may be adopted to determine or adjust the main route 300. In the example of FIG. 3, the main route 300 is a roughly S-shaped route. In another embodiment, the main route 300 may also be any other suitable shape or form, such as a roughly spiral shape.

As shown in FIG. 3, the main route 300 may include at least one pair of adjacent paths, such as paths 302 and 304, and paths 302 and 306. For example, each pair of adjacent paths may be two straight lines or curves that are parallel or approximately parallel to each other. In another embodiment, adjacent paths may not be parallel, for example, extension lines of the adjacent paths may intersect with each other.

In one or more embodiments, a spacing or gap G between each pair of adjacent paths in the main route 300 may be determined based on a width F of the angle of view 310 of at least one image sensor of the pool cleaning device 100, for example a width of a sector surrounded by dashed lines in FIG. 3. For example, the spacing G may be greater than half the width F. Additionally or alternatively, the spacing G may also be less than or equal to the width F. In addition, the spacing G may also be determined based on a physical size of the pool cleaning device 100. For example, the spacing G may be greater than a body width or cleaning width (for example, an effective working width of the roller brush or the water suction port) W of the pool cleaning device 100, or may be several times of W. For example, the spacing or gap G may be determined to satisfy that max(F/2, kW)<G≤F, wherein max( ) is a maximum function and k≥1.

The spacing G between each pair of adjacent paths in the main route 300 is determined based on at least one of the width F of the angle of view 310 and the physical size of the pool cleaning device 100, so that the pool cleaning device 100 may move according to the main route 300 which is much sparser (correspondingly, much shorter in total length) for example than the route 120 in the example of FIG. 1, and thus, for example, may be enabled to clean the pool 110 in a more efficient and energy-saving manner.

As shown in FIG. 3, the step 220 of the exemplary method 200 may be performed while controlling the pool cleaning device 100 to move on the path 302 of the main route 300 in the pool, for example, when the pool cleaning device 100 has just turned and moved onto the path 302 according to the main route 300, or when the pool cleaning device 100 has moved a predetermined distance on the path 302 according to the main route 300, or when the pool cleaning device 100 returns to the path 302 after leaving the path 302, or the like, to obtain at least one image about the current environment 320 within the angle of view 310 of the at least one image sensor of the pool cleaning device 100 from the at least image sensor, for example by a predetermined image sampling period while the pool cleaning device 100 is moving on the path 302.

Depending on the types and functions of the image sensors configured on the pool cleaning device 100, the at least one obtained image may include a color image, a gray image, a laser point cloud image, and any other suitable image. In addition, the at least one obtained image may include at least one static image and/or at least one dynamic image.

In FIG. 3, the angle of view 310 is schematically represented as a sector surrounded by a dotted line, but the actual angle of view is not limited to the angle of view 310 as shown in FIG. 3, and may depend on the type, function and number of image sensors configured on the pool cleaning device 100, for example.

Then, in the step 230, the at least one image about the current environment 320 within the angle of view 310 obtained in the step 220 may be processed and analyzed for example by any suitable method such as an image convolution neural network, to identify or recognize one or more cleanable objects within the current environment 320 corresponding to the angle of view 310, such as cleanable objects in the example of FIG. 3.

Further, in the step 230, at least one cleanable object within a predetermined range from the pool cleaning device 100 may be selected from the one or more recognized cleanable objects, as the cleaning target.

For example, at least one cleanable object whose longitudinal distance D from the pool cleaning device 100 (that is, a distance in the same direction with the pool cleaning device 100) is less than a predetermined threshold may be determined as the cleaning target, wherein the predetermined threshold may be determined according to an accuracy of image recognition or target orientation recognition, which may be 0.5 m, 0.6 m, 0.7 m, or the like, for example.

In the example of FIG. 3, the longitudinal distance D between the pool cleaning device 100 and each of the cleanable objects other than the cleanable object 325 is less than the predetermined threshold, and the longitudinal distance D between the cleanable object 325 and the pool cleaning device 100 exceeds the predetermined threshold. Thus, in the step 230, the cleanable objects other than the cleanable object 325 may be selected as cleaning targets 321, 322, 323 and 324.

In another example, in the step 230, the cleaning target may also include a cleanable object whose linear distance from the pool cleaning device 100 is less than a predetermined threshold. In addition, in the step 230, for example, a range for selecting the cleaning target may be determined based on an intersection part between the angle of view 310 and a geometric shape (e.g., a rectangle, a circle, a trapezoid, etc.) with a predetermined size.

In addition, in the step 230, together with the identification of the cleaning targets 321, 322, 323, and 324, or separately, a positioning may be performed on the determined cleaning targets 321, 322, 323 and 324. For example, a relative distance and orientation with respect to the pool cleaning device 100 may be determined for each of the cleaning targets 321, 322, 323 and 324, and/or an absolute position in the pool 110 (e.g. a coordinate in a coordinate system corresponding to pool 110) may be determined for each of the cleaning targets 321, 322, 323 and 324.

For example, the position of each of the cleaning targets 321, 322, 323 and 324 may be determined based on at least one image obtained in the step 220 through any suitable image processing method or target orientation identification method. Additionally, or alternatively, the position of each of the cleaning targets 321, 322, 323, and 324 may also be determined based on sensed values from one or more other sensors configured on or in the pool cleaning device 100, such as a distance sensor (for example, an ultrasonic sensor) and a spatial attitude sensor (for example, an inertial measurement unit).

Then, the step 240 may be performed to control the pool cleaning device 100 to leave the path 302 in the main route 300, to clean the cleaning targets 321, 322, 323 and 324 determined in the step 230.

In one or more embodiments, a sequence or route for cleaning respective cleaning targets in the step 240 may be determined based on one or more of a distance between each cleaning target and the pool cleaning device 100 determined in the step 230 (e.g., the longitudinal distance or the linear distance), a regional position of each cleaning target relative to the path 302 where the pool cleaning device 100 is currently located (e.g., a left region or a right region), a number of the cleaning targets in respective regions divided by the path 302 (e.g., the region between paths 302 and 304, and the region between paths 302 and 306), and so on.

For example, a cleaning target with a shorter longitudinal distance from the pool cleaning device 100 may be cleaned earlier. For example, the cleaning target with the shortest longitudinal distance from the pool cleaning device 100 may be determined, and then, with respect to the path 302, after cleaning all the cleaning targets on the same side as the determined cleaning target, all the cleaning targets on a different side from the determined cleaning target may be cleaned, wherein, for all the cleaning targets on each side, the cleaning sequence may be determined based on the longitudinal distances of respective cleaning target on the side from the pool cleaning device 100, for example. In addition, a shortest path for clean all cleaning targets may be determined based on an orientation relationship or topological structure among respective cleaning targets.

In an embodiment, as shown in FIG. 3, the pool cleaning device 100 may be controlled to leave the path 302 and move toward the cleaning target 321 on a side of the path 302 (for example, on the left side in the example of FIG. 3, that is, in a region between the paths 302 and 304), as shown by an arrow pointing to the cleaning target 321 from the path 302 in FIG. 3, to clean the cleaning target 321.

After cleaning the cleaning target 321, the pool cleaning device 100 may be controlled to continue to move toward the cleaning target 322 on the same side as the cleaning target 321 with respect to the path 302 and in the region between the paths 302 and 304, as shown by an arrow pointing from the cleaning target 321 to the cleaning target 322 in FIG. 3, to continue to clean the cleaning target 322.

After cleaning the cleaning targets 321 and 322 on one side of the path 302, the pool cleaning device 100 may be controlled to return to the path 302. For example, the pool cleaning device 100 may be controlled to return to a position P1 on the path 302 by a route perpendicular to the path 302, as shown by an arrow pointing to P1 from the cleaning target 322 in FIG. 3.

Then, it may be checked whether there are still cleaning targets on the other side of the path 302, for example, on the right side in the example of FIG. 3, that is, in a region between the paths 302 and 306.

In an embodiment, it may be checked whether there are still cleaning targets to be cleaned on the other side of the path 302, for example based on whether a current number of cleaning targets, which have been cleaned, has reached a total number of cleaning targets determined in the step 230.

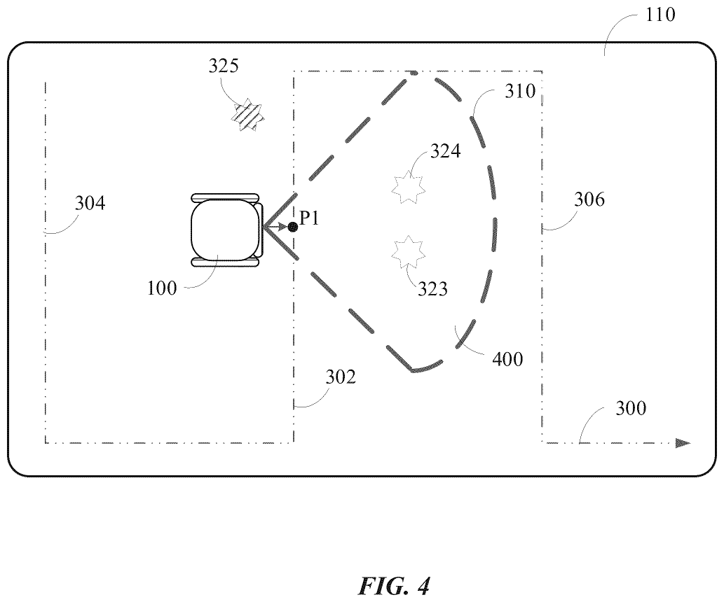

In another embodiment, as shown in FIG. 4, during or when the pool cleaning device 100 returns to the position P1 on the path 302 by a route perpendicular to the path 302, at least one image about a current environment 400 within the angle of view 310 may be obtained in a current posture state where a current orientation of the pool cleaning device 100 is substantially perpendicular to the path 302. Then, it may be determined, based on the at least one image about the current environment 400, whether there is still a cleaning target on the other side of the path 302, for example on the right side of the path 302 in the example of FIG. 3 or in the region between the paths 302 and 306, through any suitable image processing and analysis method or target recognition method such as an image convolution neural network.

For example, after cleaning the cleaning targets 321 and 322 on one side of the path 302, in a case where it is determined that there are no cleaning targets to be cleaned on the other side of the path 302 (for example, on the right side in the example of FIG. 3, that is, in the region between the paths 302 and 306), the step 250 may be executed to control the pool cleaning device 100 to return to the position P1 on the path 302, and to continue to move by the main route 300 from the position P1.

In a case where it is determined that there are still cleaning targets 323 and 324 to be cleaned on the other side of the path 302 (for example, on the right side in the example of FIG. 3, that is, in the region between the paths 302 and 306), as shown in FIG. 3, the pool cleaning device 100 may be controlled to start from the position P1 on the path 302, to leave the path 302, and then to move toward the cleaning target 322 on the other side of the path 302 (for example, on the right side in the example of FIG. 3, that is, in the region between the paths 302 and 306) as shown by an arrow pointing to the cleaning target 322 from P1 in FIG. 3, to continue to clean the cleaning target 322.

After cleaning the cleaning target 323, the pool cleaning device 100 may be controlled to continue to move toward the cleaning target 324 on the same side as the cleaning target 323 with respect to the path 302 and in the region between the paths 302 and 306, as shown by an arrow pointing from the cleaning target 323 to the cleaning target 324 in FIG. 3, to continue to clean the cleaning target 324.

After cleaning the cleaning targets 323 and 324 on the other side of the path 302, the step 250 may be performed to control the pool cleaning device 100 to return to the path 302. For example, the pool cleaning device 100 may be controlled to return to a position P2 on the path 302 by a route perpendicular to the path 302, as shown by an arrow pointing to P2 from the cleaning target 324 in FIG. 3. Then, the pool cleaning device 100 may be controlled to continue moving along the main route 300 from the position P2 on the path 302.

In the above examples, while controlling the pool cleaning device 100 to move along the main route 300, at least one cleaning target within a predetermined range from the pool cleaning device 100 is identified based on at least one obtained image through an appropriate image processing and analysis method or target identification method, and the pool cleaning device 100 is controlled to temporarily leave the main route 300 to clean the at least one identified cleaning target, and then to return to the main route 300 and continue to move along the main route 300. Thus, the pool cleaning device 100 is enabled to clean the pool 110 by a sparse (and accordingly, shorter) route while avoiding cleaning omissions, so that the cleaning coverage rate may be ensured in a more efficient and energy-saving manner.

In the above examples, the main route 300 covers at least a part of the bottom of the pool 110. In another embodiment, the main route 300 may also cover at least a part of the wall and/or water surface of the pool 110.

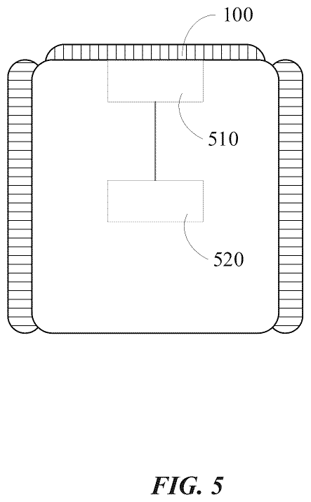

FIG. 5 illustrates an example of a pool cleaning device 100 in an embodiment. As shown in FIG. 5, the pool cleaning device 100 may include at least one image sensor 510 and a controller 520.

The image sensor 510 may be configured to obtain or catch at least one image about a current environment (e.g., the current environment 320 or 400 in the above examples) within the angle of view of the image sensor 510 (e.g., the angle of view 310 in the above examples) while the pool cleaning device 100 is controlled by the controller 520 and is moving along the main route (e.g., the main route 300 in the above examples) covering at least a part of the complete map of the pool.

In various embodiments, the image sensor 510 may include, but is not limited to, a camera, a radar, a LIDAR, and so on. Depending on the type and function of the image sensor 510, the at least one obtained image may include at least one image in any suitable form such as a color image, a grayscale image, a laser point cloud image, and so on. In addition, the at least one obtained image may include at least one static image and/or at least one dynamic image.

The controller 520 may include a central processing unit (CPU), a graphics processing unit (GPU) or other types or forms of processing circuits or chips with data processing capability and/or instruction execution capability, such as a field programmable gate array (FPGA). For example, in a case where the pool cleaning device 100 is configured to support processing based on a deep learning model such as a convolutional neural network or an artificial intelligence processing model, the controller 520 may further include a circuit such as a multiply accumulator (MAC) dedicated to accelerating some operations such as convolution operation, and/or may further include a circuit or chip such as a brain processor (BPU) which is more suitable for the operations and processing in the deep learning model or the artificial intelligence processing model.

For example, the controller 520 may be configured to perform the above exemplary method 200 and/or one or more operations or processes required for the operation of the pool cleaning device 100, according to instructions from a control terminal of the pool cleaning device 100 and/or one or more programs pre-programmed and stored in a memory in the pool cleaning device 100, and based on sensed data from the image sensor 510. For example, the controller 520 may be configured to execute the programs to control the moving mechanism of the pool cleaning device 100 to drive the pool cleaning device 100 to move by a main route covering at least a part of a complete map of a pool, to obtain at least one image about a current environment within an angle of view of the at least one image sensor from the at least one image sensor, to determine at least one cleaning target in the current environment based on the at least one image, wherein a distance between the at least one cleaning target and the pool cleaning device 100 may be less than a predetermined threshold. Further, the controller 520 may be configured to execute the programs to control the moving mechanism to drive the pool cleaning device 100 to leave a current path in the main route to clean the at least one cleaning target, and to control the moving mechanism to drive the pool cleaning device 100 to return to the current path after cleaning the at least one cleaning target, to continue moving by the main route.

The basic principles of the present disclosure have been described above in connection with the embodiments. However, it is appreciated that the advantages, benefits, effects, and so on, which have been mentioned herein, are only examples rather than limitations, and these advantages, benefits, effects, and so on should not be considered as necessary for each embodiment of this disclosure. In addition, the foregoing details are only for the purpose of illustration and easy understanding, rather than limitations, and the foregoing details do not limit that the present disclosure must be implemented with the foregoing details.

The block diagrams of devices, apparatuses, equipment and systems involved in this disclosure are only illustrative examples and are not intended to require or imply that they must be connected, arranged or configured in the manners shown in the block diagrams. In various embodiments, these devices, apparatuses, equipment and systems may be connected, arranged or configured in any suitable manners.

In addition, wordings such as “including”, “comprising” and “having” are open words, which mean and is interchangeable with the wording “including but not limited to”. The wordings “or” and “and” herein refer to and may be interchangeable with “and/or” unless the context clearly indicates otherwise. The wording “such as” herein refers to and may be interchangeable with the phrase “such as but not limited to”.

It is appreciated that in the apparatuses, equipment and methods of the present disclosure, each component or step may be decomposed and/or recombined. Any decomposition and/or recombination should be regarded as equivalents of the present disclosure.

In this disclosure, modifiers without quantifiers such as “first” and “second” are intended to distinguish different elements/components/circuits/modules/apparatuses/steps, and are not used to emphasize an order, positional relationship, importance, priority level, or the like. Sometimes, modifiers with quantifiers such as “first piece of” and “second piece of” may be used to emphasize the order, positional relationship, importance, priority level and so on for different components/components/circuits/modules/apparatuses/steps.

The foregoing description has been presented for purposes of illustration and description. This description is not intended to limit the embodiments of the present disclosure to the forms disclosed herein. Although several example aspects and embodiments have been described above, those skilled in the art may recognize some variations, modifications, changes, additions and sub-combinations thereof.

1. A method for controlling a pool cleaning device, comprising:
controlling the pool cleaning device to move in a pool by a main route, the main route comprising multiple predetermined paths covering at least a part of a map of the pool;
obtaining at least one first image from at least one image sensor of the pool cleaning device, the at least one first image representing a current environment within an angle of view of the at least one image sensor;
determining at least one cleaning target in the current environment and a position of the at least one cleaning target based on the at least one first image;
controlling the pool cleaning device to leave a first predetermined path of the main route and move toward the position of the at least one cleaning target, the pool cleaning device being currently moving on the first predetermined path, and the at least one cleaning target being absorbed and cleaned when the pool cleaning device moves near and/or across the at least one cleaning target; and
controlling the pool cleaning device to return to the first predetermined path to continue moving by the first predetermined path after the at least one cleaning target has been cleaned.

2. The method of claim 1, wherein the determining the at least one cleaning target in the current environment and the position of the at least one cleaning target based on the at least one first image comprises:
determining one or more cleanable targets in the current environment based on the at least one first image; and
determining at least one cleanable target within a predetermined range from the one or more cleanable targets as the at least one cleaning target.

3. The method of claim 2, wherein the determination of the one or more cleanable targets in the current environment comprises performing an image recognition on the at least one first image to recognize the one or more cleanable targets. and the predetermined range depends on an accuracy of the image recognition.

4. The method of claim 1, wherein the main route further comprises a second predetermined path adjacent to the first predetermined path, and a spacing between the second predetermined path and the first predetermined path depends on a width of the angle of view or a physical size of the pool cleaning device.

5. The method of claim 4, wherein the spacing is more than half of the width and/or is less than or equal to the width.

6. The method of claim 4, wherein the second predetermined path is parallel to the first predetermined path.

7. The method of claim 4, wherein the spacing is larger than a body width of the pool cleaning device.

8. The method of claim 1, wherein the control of the pool cleaning device to leave the first predetermined path of the main route and move toward the position of the at least one cleaning target comprises:
controlling the pool cleaning device to clean at least one first cleaning target among the at least one cleaning target, the at least one first cleaning target being at a side of the first predetermined path and being absorbed and cleaned when the pool cleaning device moves near and/or across the at least one first cleaning target;
controlling the pool cleaning device to return to the first predetermined path after the at least one first cleaning target has been cleaned; and
in a case where the at least one cleaning target further comprises at least one second cleaning target at other side of the first predetermined path, controlling the pool cleaning device to leave the first predetermined path to clean the at least one second cleaning target.

9. (canceled)

10. The method of claim 8, wherein the control of the pool cleaning device to return to the first predetermined path after the at least one first cleaning target has been cleaned comprises:
obtaining at least one second image from the at least one image sensor, during returning to the first predetermined path, the at least one second image representing a current environment within a current angle of view; and
determining, based on the at least one second image, whether the at least one cleaning target comprises the at least one second cleaning target.

11. The method of claim 8, wherein the at least one first cleaning target comprising a nearest cleaning target nearest to the pool cleaning device when the at least one cleaning target is determined based on the at least one first image.

12. The method of claim 1, wherein a route of the pool cleaning device returning to the first predetermined path is perpendicular to the first predetermined path.

13. A pool cleaning device comprising:
a moving mechanism comprising at least one moving wheel and/or crawler drivable by a motor;
at least one image sensor comprising at least one camera or radar;
a memory with programs stored therein; and
a controller configured to execute the programs to control the moving mechanism to drive the pool cleaning device to move by a main path in a pool, to obtain at least one first image about a current environment within an angle of view of the at least one image sensor from the at least one image sensor, to determine at least one cleaning target in the current environment and a position of the at least one cleaning target based on the at least one first image, to control the moving mechanism to drive the pool cleaning device to leave the main path and move toward the position of the at least one cleaning target to clean the at least one cleaning target, and to control the moving mechanism to drive the pool cleaning device to return to the main path to continue moving by the main path after cleaning the at least one cleaning target.

14. The pool cleaning device of claim 13, wherein the controller is configured to execute the programs to determine one or more cleanable targets in the current environment based on the at least one first image, and to determine at least one cleanable target within a predetermined range from the one or more cleanable targets as the at least one cleaning target.

15. The pool cleaning device of claim 14, wherein the predetermined range depends on a predetermined threshold related to an accuracy of image recognition.

16. The pool cleaning device of claim 13, wherein a spacing between the main path and an adjacent path of the main path depends on a width of the angle of view or a physical size of the pool cleaning device.

17. The pool cleaning device of claim 16, wherein the spacing is more than half of the width and/or is less than or equal to the width, or the spacing is larger than a body width of the pool cleaning device.

18. The pool cleaning device of claim 13, wherein the controller is configured to execute the programs to control the moving mechanism to drive the pool cleaning device to clean at least one first cleaning target among the at least one cleaning target, the at least one first cleaning target being at a side of the main path, to control the moving mechanism to drive the pool cleaning device to return to the main path after cleaning the at least one first cleaning target, and in a case where the at least one cleaning target further comprises at least one second cleaning target at other side of the main path, to control the moving mechanism to drive the pool cleaning device to leave the main path to clean the at least one second cleaning target.

19. The pool cleaning device of claim 18, wherein the controller is configured to execute the programs to obtain at least one second image about a current environment within a current angle of view during returning to the main path from the at least one image sensor after cleaning the at least one first cleaning target, and to determine, based on the at least one second image, whether the at least one cleaning target comprises the at least one second cleaning target.

20. The pool cleaning device of claim 13, wherein a sequence for cleaning the at least one cleaning target depends on a distance between the at least one cleaning target and the pool cleaning device.
